(19) United States
(12) Patent Application Publication
(10) Pub. No.: US 2006/0169763 A1
(43) Pub. Date: Aug. 3, 2006

(54) Automatically labeling and inspecting apparatus and method of use

(75) Inventor: Chien Yueh Shiang, Bade City (TW)

Correspondence Address: BIRCH STEWART KOLASCH & BIRCH, PO BOX 747, FALLS CHURCH, VA, 22040-0747, US

(73) Assignee: All Fine Technology Co., LTD.

(21) Appl. No.: 11/248,218

(22) Filed: Oct. 13, 2005

(30) Foreign Application Priority Data
Jan. 31, 2005 (JP) 094102955

(51) Int. Cl. G06F 17/00; G06F 7/00

(52) U.S. Cl. 235/375; 235/376

(57) ABSTRACT

An automatically marking, reading and distinguishing apparatus, which programmingly controls a conveyance of a printed circuit board, includes a table, an information label generator, at least one flipping device, and an image reading and distinguishing device. The table includes a first area and a second area. The information label generator is disposed corresponding to the first area for generating and labeling an information label on the printed circuit board. The image reading and distinguishing device is disposed corresponding to the second area to determine whether the information label is readable. The flipping device is located under the table and has a rotating part and at least one set of jigs for flipping the labeled or readable printed circuit boards.

This application claims priority based on a Taiwanese patent application No. 094102955 filed on Jan. 31, 2005.

### BACKGROUND OF THE INVENTION

1. Field of the Invention

The present invention relates generally to an automatically labeling and inspecting apparatus. Particularly, the present invention relates to an automatically labeling and inspecting apparatus for labeling and inspecting a printed circuit board.

2. Description of the Relative Art

Quality control is an important issue for the printed circuit board manufacture process. During the manufacture, each connection between the element and the printed circuit board has to be checked one by one. In order to trace the printed circuit board during the manufacture process and afterward, a bar code is printed or attached on the printed circuit board. Once any piece of printed circuit board has problem, the whole manufacture process information may be traced through the bar code.

Taiwanese Patent Publication No. 536104 dated on Jul. 15, 2002 discloses a laser bar code printer 6 and a bar code reader 4 having a charge coupled device (CCD). As FIG. 1 shows, the relative art device positions a printed circuit board 7 and uses a transmission device 8 to adjust the position of the printed circuit board 7. The relative device may handle only single printed circuit board and single side at one time. In addition, the relative art device gives a warning, shuts down the process, and manually marks the defective printed circuit board.

### SUMMARY OF THE INVENTION

It is an object of the present invention to provide an apparatus and a method for generating an information label, reading and distinguishing the information label on a printed circuit board, and confirming the information labels are distinguishable.

It is another object of the present invention to provide an apparatus for retrieving the printed circuit boards having undistinguishable information labels.

The present invention achieves these and other objectives by providing an automatically labeling and inspecting apparatus, which programmingly controls a conveyance of a printed circuit board. The apparatus includes a table, an information label generator, an image reading and distinguishing device, and a marking device. The table includes at least one area. The information label generator is disposed corresponding to one of the areas for generating an information label on the printed circuit board. The image reading and distinguishing device is disposed corresponding to one of the areas for reading and distinguishing the information label on the printed circuit board. The marking device is disposed by a side of the table for marking a printed circuit board having an undistinguishable information label.

The other embodiment of the present invention provides an automatically labeling and inspecting apparatus, which programmingly controls a conveyance of a printed circuit board. The apparatus includes a table, an information label generator, an image reading and distinguishing device, and a marking device. The table includes a first area and a second area. The information label generator is disposed corresponding to the first area for generating an information label on the printed circuit board. The image reading and distinguishing device is disposed corresponding to the second area for reading and distinguishing the information label on the printed circuit board. The marking device is disposed by a side of the second area for marking a printed circuit board having an undistinguishable information label.

The present invention also provides a method for automatically marking, reading and distinguishing a printed circuit board. The method includes: conveying a printed circuit board to a table; positioning the printed circuit board in a first area of the table and generating an information label on the printed circuit board; positioning the printed circuit board in a second area of the table and reading/distinguishing the information label on the printed circuit board; flipping the printed circuit board in the first area; and flipping the printed circuit board in the second area.

Generally the apparatus and method provided by the present invention are put at the beginning end of all manufacture process. The information label, such as a bar code, may be traced anytime through the all manufacture process. The apparatus and method of the present invention, however, may be used in any segment in the manufacture process to serve different functions.

### BRIEF DESCRIPTION OF THE DRAWINGS

FIG. 1 is a perspective view of a relative art device.

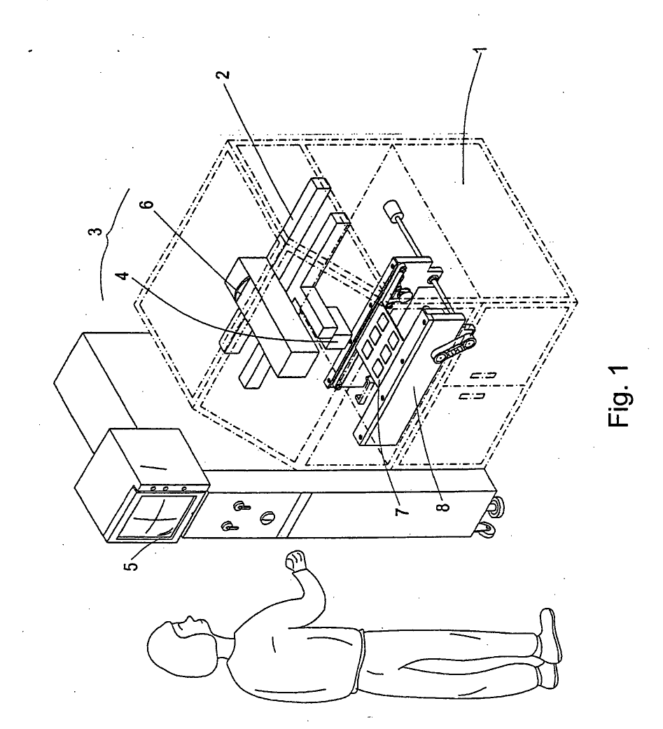

FIG. 2 is a perspective view of one embodiment of the present invention.

FIG. 3 shows an embodiment of conveying a printed circuit board to table.

FIG. 4 shows an embodiment of the X-Y 2D movable flatbed.

FIG. 5 shows an embodiment of retrieving the printed circuit board having undistinguishable information label.

FIG. 6 shows an embodiment of the cleaning wheels.

FIG. 7 is a flow chart showing an embodiment of the process of the present invention.

### DETAILED DESCRIPTION OF THE PREFERRED EMBODIMENT

The preferred embodiments of the present invention are illustrated hereinafter accompanying with attached drawings.

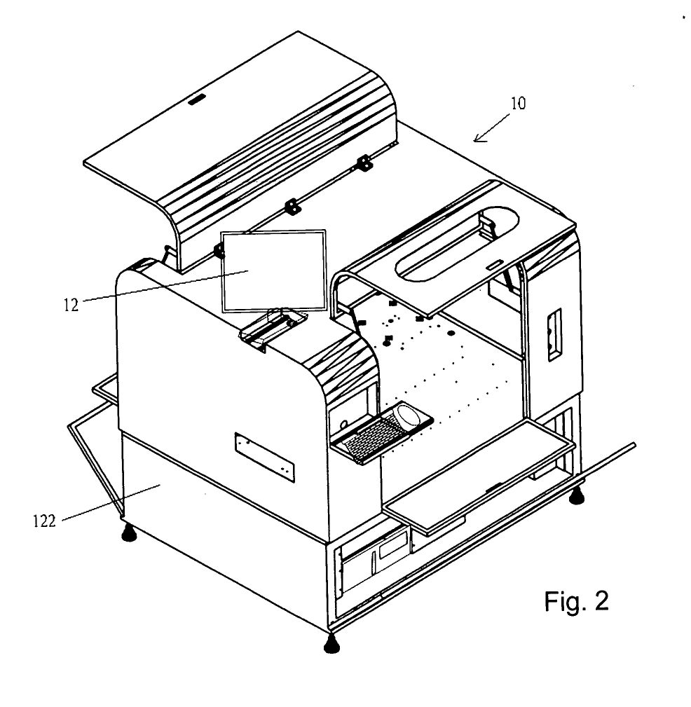

Please refer to FIG. 2 to FIG. 4, which show a preferred embodiment of the present invention. The present invention provides an automatically labeling and inspecting apparatus, which uses a computer 12 to programmingly control a conveyance of a plurality of printed circuit boards 14. Preferably, a controlling program written from Visual Basic, C++, PLC, other similar programming language or the combination thereof is used to control this conveyance. The apparatus 10 further includes a base 122 and a board supplier 18. The main structure of the apparatus 10 includes a table 20, an information label generator 30, an image reading and distinguishing device 50, and a marking device 60. The table 20 includes a first area 22 and a second area 24. The information label generator 30 is disposed corresponding to the first area 22. In this embodiment, the information label generator 30 is disposed on a cantilever 16 above the base 122 or a position beneath the table 20. The information label generator 30 generates an information label 32 on a printed circuit board 14 in the first area 22.

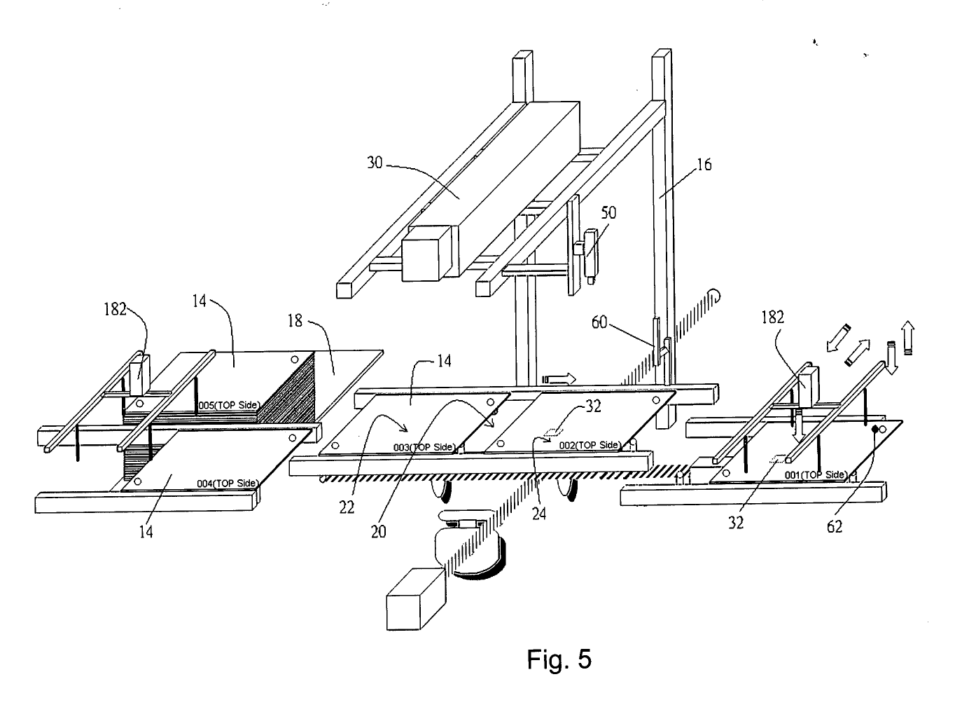

The image reading and distinguishing device 50 is disposed corresponding to the second area 24 for reading and distinguishing the information label 32 on the printed circuit board 14 in the second area 24. Preferably, the image reading and distinguishing device 50 includes a charge coupled device (CCD). The image reading and distinguishing device 50 is preferably disposed on the cantilever 16 or beneath the table 20. The marking device 60 is adapted to mark a printed circuit board 14 having an unreadable or undistinguishable information label. Referring to FIG. 5, the marking device 60 is enabled to put an undistinguishable mark 62 on the printed circuit board 14 when the image reading and distinguishing device 50 is unable to read or distinguish the information label 32. Then a vacuum board-sucking device 182 retrieves the marked printed circuit board 14 to a retrieving area, which means the printed circuit board 14 having the undistinguishable mark 62 is out from the process at this time.

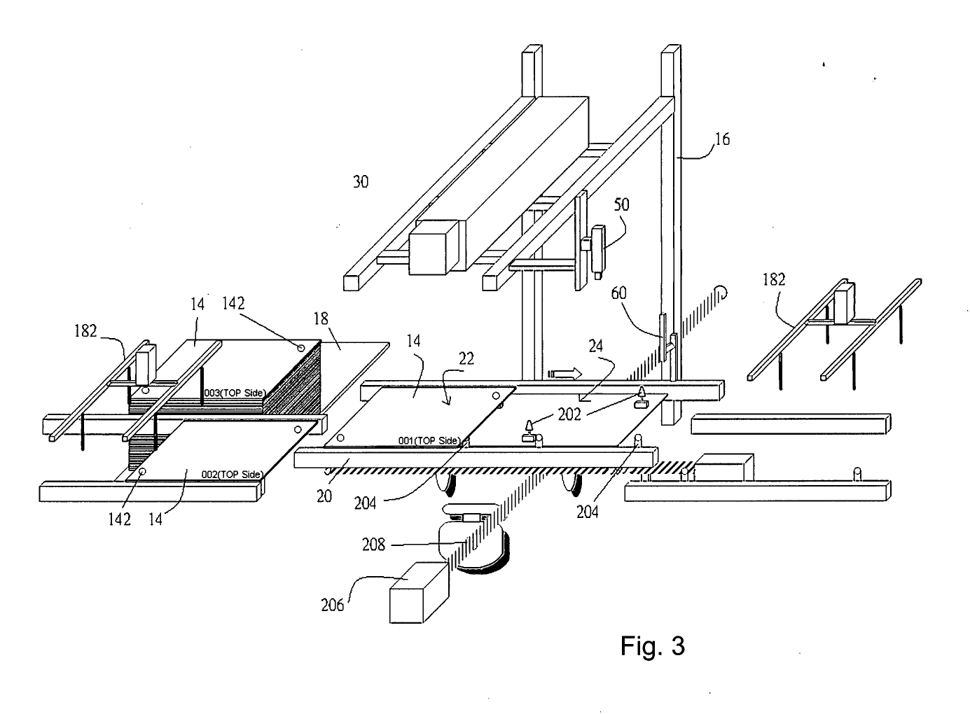

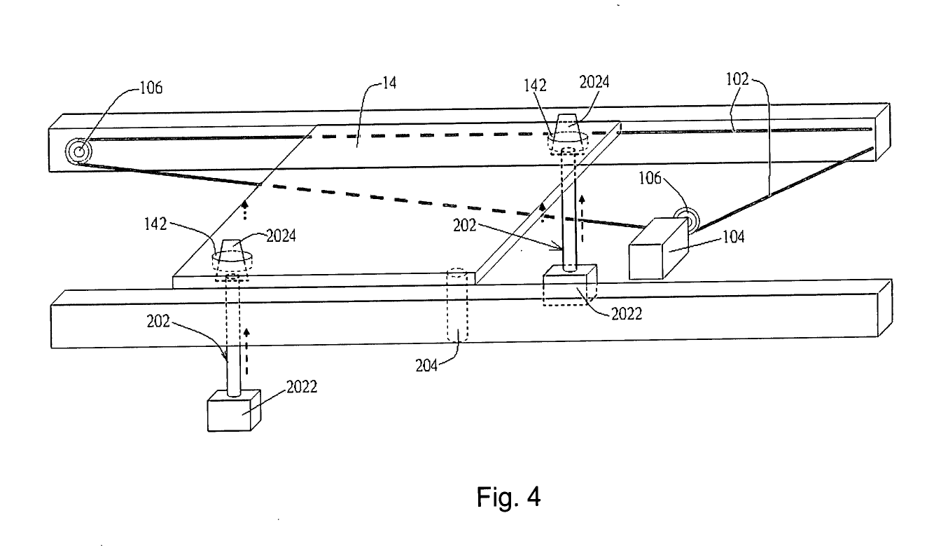

Particularly, the information label generator 30 may include a laser bar code labeling device or a jet printing bar code labeling device. In FIG. 3, sensors 204 located in predetermined positions detect whether the printed circuit board 14 enters into a particular area when the printed circuit board 14 is conveyed to a X-Y 2-D movable flatbed of the table 20. According to the detection result, computer 12 enables a belt to drive the printed circuit board 14 and proceeds to the next step. Supporting members 202 support and position the printed circuit board 14 through two holes 142 diagonally formed on the printed circuit board 14. The relative elevation of the printed circuit board 14 may be adjusted by moving the supporting member 202 or the flatbed. The flatbed also includes a driving device for controlling a X-Y 2D movement of the flatbed. Preferably the driving device includes a combination of a motor 206 and a threaded guidance rod 208 to control the movement. FIG. 4 shows an embodiment of the flatbed of the present invention. A conveying device shown in this embodiment conveys printed circuit board 14 by using a combination of a belt 102, bearing 106, and a motor 104. Computer 12 controls the conveyance process. A positioning member (not shown) rises and blocks the printed circuit board 14 when the sensor 204 detects that the printed circuit board 14 exists in the first area 22. In this preferred embodiment, the positioning member is a positioning pin. Two supporting members also rise and cooperate with the positioning member to position the printed circuit board 14. Similar printed circuit board 14 positioning method is used in the second area 24. In addition, the supporting member 202 includes a combination of a cylinder 2022 and a piston rod 2024, which has a cone-shaped tip.

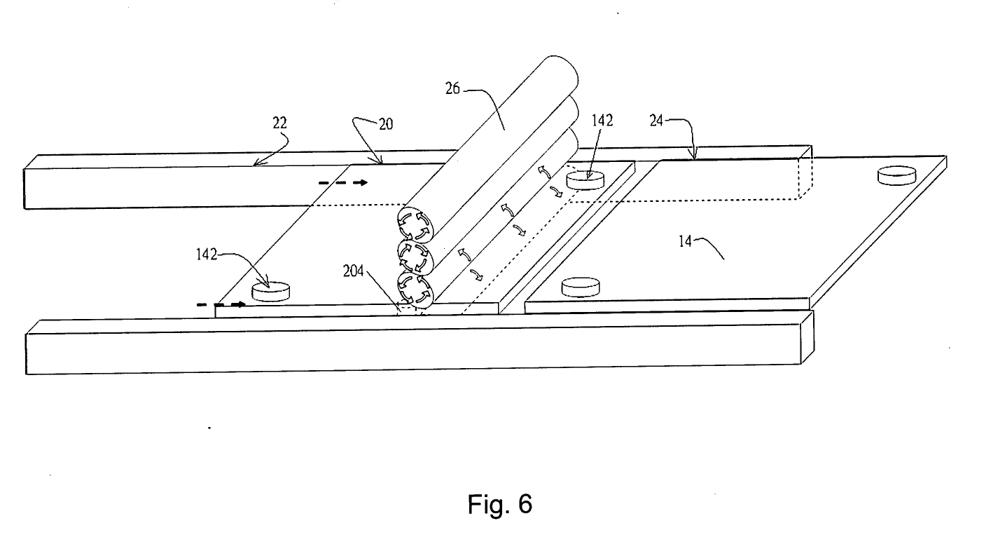

Referring to FIG. 6, a plurality of cleaning wheels 26 are disposed between the first area 22 and the second area 24. The sticky cleaning wheels 26 clean the information label 32 and bring stains or dirt away from the information label 32.

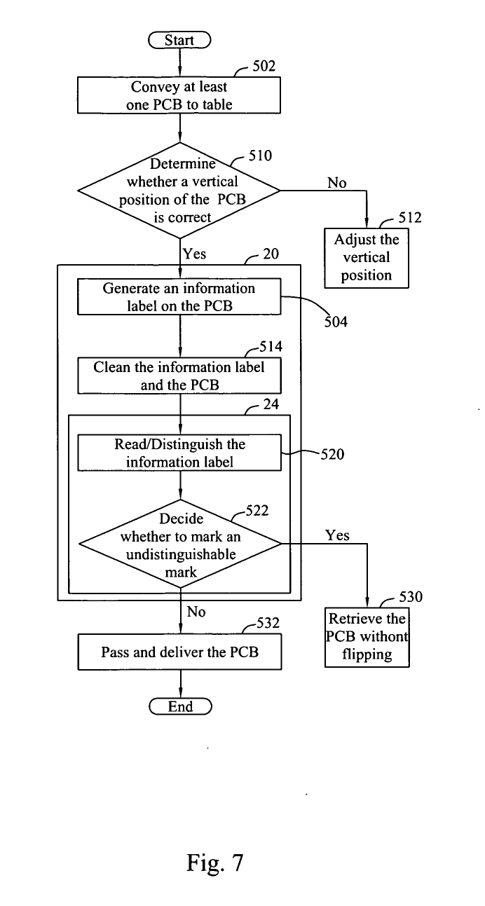

The present invention also provides a method for automatically labeling and inspecting the printed circuit board 14. This method uses a computer 12 to proammingly control a conveyance of a printed circuit board 14. Referring to FIG. 7, step 502 conveying at least one printed circuit board to table 20. in step 510, determine whether a vertical position of the printed circuit board 14 is correct. If it is not correct, go to step 512 and adjust the vertical position of the printed circuit board 14 by adjusting the supporting members 202 or adjusting the flatbed.

In step 504, position the printed circuit board 14 in the first area 22 of the table 20 and generate an information label 32 on the printed circuit board 14.

In step 514, cleaning wheels clean the information label 32 and the printed circuit board 14.

In step 520, position the printed circuit board 14 in the second area 24 of the table 20 and read/distinguish the information label 32 on the printed circuit board 14. Then in step 522, decide whether to mark an undistinguishable mark on the printed circuit board 14. If no, which means the information label 32 is distinguishable, go to step 532, pass and deliver the printed circuit board 14. If yes, go to step 530, retrieves the printed circuit board without flipping.

Sensors located in predetermined position, including the first and second areas, detect whether the printed circuit board 14 enters into a corresponding area and return detection results to the computer 12. The computer 12 controls the process based on the detection results.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

1. An automatically labeling and inspecting apparatus programmingly controlling a conveyance of at least one printed circuit board, said apparatus comprising:
a table having at least one area;
an information label generator disposed corresponding to one of said areas, said information label generator generating an information label on the printed circuit board in said area;
an image reading and distinguishing device disposed corresponding to one of said areas, said image reading and distinguishing device reading and distinguishing said information label on the printed circuit board in said area; and
a marking device disposed by a side of said table for marking a printed circuit board having an undistinguishable information label.

2. The apparatus of claim 1, further comprising a vacuum board-sucking device for retrieving the printed circuit board marked by said marking device.

3. The apparatus of claim 1, wherein said table includes a flatbed, said flatbed is X-Y 2-dimentionally movable.

4. The apparatus of claim 3, wherein said flatbed includes:
at least one supporting member respectively disposed in each of said areas;
at least one positioning member respectively disposed in each of said areas; and
a driving device for controlling a movement of said flatbed.

5. The apparatus of claim 4, wherein said driving device includes a motor and a threaded guidance rod.

6. The apparatus of claim 5, wherein said supporting member includes a cylinder and a piston rod.

7. The apparatus of claim 6, wherein said positioning member includes a positioning pin.

8. The apparatus of claim 1, further comprising a plurality of cleaning wheels disposed between said areas.

9. The apparatus of claim 1, wherein said information label generator includes a laser bar code labeling device.

10. The apparatus of claim 1, wherein said information label generator includes a jetting/printing bar code labeling device.

11. A method for automatically labeling and inspecting a printed circuit board, comprising:
conveying at least one printed circuit board to a table;
positioning said printed circuit board in a first area of said table and generating an information label on said printed circuit board;
positioning said printed circuit board in a second area of said table and reading and distinguishing and said information label on said printed circuit board; and
marking said printed circuit board when said information label on said printed circuit is undistinguishable.

12. The method of claim 11, further comprising detecting an entering of said printed circuit board in said first area and in said second area.

13. The method of claim 11, further comprising retrieving said marked printed circuit board by using a vacuum board-sucking device.

14. The method of claim 11, further comprising 2-dimentionally moving a flatbed of said table to position said printed circuit board.

15. The method of claim 11, further comprising cleaning said information label by using a plurality of cleaning wheels disposed between said first area and said second area.

16. An automatically labeling and inspecting apparatus programmingly controlling a conveyance of at least one printed circuit board, said apparatus comprising:
a table having a first area and a second area;
an information label generator disposed corresponding to said first area, said information label generator generating an information label on the printed circuit board in said first area;
an image reading and distinguishing device disposed corresponding to said second area, said image reading and distinguishing device reading and distinguishing said information label on the printed circuit board in said second area; and
a marking device disposed by a side of said second area for marking a printed circuit board having an undistinguishable information label.

17. The apparatus of claim 16, further comprising a vacuum board-sucking device for retrieving the printed circuit board marked by said marking device.

18. The apparatus of claim 16, wherein said table includes a flatbed, said flatbed is X-Y 2-dimentionally movable.

19. The apparatus of claim 18, wherein said flatbed includes:
a plurality of supporting members respectively disposed in each of said areas;
a plurality of positioning members respectively disposed in each of said areas; and
a driving device for controlling a movement of said flatbed.

20. The apparatus of claim 16, further comprising a plurality of cleaning wheels disposed between said first area and said second area.

21. The apparatus of claim 16, wherein said information label generator includes a laser bar code labeling device.

22. The apparatus of claim 16, wherein said information label generator includes a jetting/printing bar code labeling device.

23. The apparatus of claim 16, further comprising a sensor for detecting an entering of said printed circuit board.
